(19) United States
(12) Patent Application Publication
(10) Pub. No.: US 2015/0237828 A1
(43) Pub. Date: Aug. 27, 2015

(54) FUN BALL

(71) Applicant: Rosse Mary Peavey, League City, TX (US)

(72) Inventor: Rosse Mary Peavey, League City, TX (US)

(21) Appl. No.: 14/625,317

(22) Filed: Feb. 18, 2015

Related U.S. Application Data
(60) Provisional application No. 61/941,409, filed on Feb. 18, 2014.

(51) Int. Cl. A01K 15/02

(52) U.S. Cl. CPC A01K 15/025

(57) ABSTRACT

An interactive fun pet toy that contains both remote and sound activated capabilities comprising a hollow, transparent, spherical ball having a wheeled toy inside which is capable of emitting light and sound in response to external sound or remotely controlled signals.

### CLAIM OF PRIORITY

This patent application claims priority under 35 USC 119 (e) (1) from U.S. Provisional Patent Application Ser. No. 61/941,409 filed Feb. 18, 2014, of common inventorship herewith entitled, “Fun Ball” which is incorporated herein by reference as though the same were set forth in its entirety.

### FIELD OF THE INVENTION

The present invention pertains to the field of mechanical electronics, and more specifically to the field of remotely controlled mechanisms.

### BACKGROUND OF THE INVENTION

The prior art has put forth several designs for remotely controlled mechanisms. Among these are:

U.S. Pat. No. 8,137,152 to lin Wei Tsai describes a remote control ball assembly includes a housing, an actuating device having a circuit board disposed in the housing and having a processing device and a signal receiving device attached to the circuit board. Two motors each include a wheel attached to a spindle and contacted with the housing. A radio transmitter includes another processing device and an angle detector and a signal emitting device attached to another circuit board for detecting a status of the radio transmitter and for emitting the status signal to the signal receiving device. This device then actuates the motors and the wheels to operate or to move the housing on land and on water without being operated by the fingers of the user.

U.S. Pat. No. 5,439,408 to William T. Wilkinson describes a remote controlled movable ball amusement device which includes a hollow sphere having a propulsion mechanism within the sphere. The propulsion mechanism includes a receiver and a drive unit. The drive unit causes the sphere to move when actuated by the receiver. A remote transmitter sends signals to the receiver for causing the actuation of the drive unit.

U.S. Pat. No. 4,438,588 to John E. Martin describes an improved system of the type having a ball or sphere and within it a remote control powered vehicle, has provisions for determining vehicle orientation for more efficient control including one or more of transparent ball portions, color ball portions and forward illuminating spotlight. An ability to store the vehicle with the ball inflated is provided by a mercury switch which turns off power when the vehicle is inverted. Angle strips improve traction externally and a soft semi inflated ball is used for better internal traction between vehicle and ball wall.

None of these prior art references describe the present invention.

### SUMMARY OF THE INVENTION

It is an object of the present invention to provide an interactive fun pet toy that contains both remote and sound activated capabilities.

### BRIEF DESCRIPTION OF THE DRAWINGS

FIG. 1 is an illustrative diagonal view showing a transparent plastic bouncing ball, a motion and noise sensor, a voice recorder, a laser, and motor housing.

FIG. 2 is a prototypical diagonal view showing a transparent plastic ball in an opened position with a toy dog inside it, and a remote control lying next to the transparent plastic ball.

FIG. 3 is a prototypical diagonal view showing a remote control with an on and off switch, a forward button and a reverse button.

### DETAILED DESCRIPTION OF THE INVENTION

Pets are a major part of many families worldwide. Offering their owners companionship, protection and love, a strong emotional bond often develops between pets and their owners. Many equate the experience of owning a pet to that of having a young child and invest an abundance of time and energy into caring for them. As with raising children, pet ownership carries the responsibility of caring and providing for that pet. To ensure their dog or cat is happy and healthy, pet owners know their animals need plenty of food, water, exercise and companionship. Playful interaction between pet and owner is an essential tool in cementing the bond animals and humans share. From tossing a ball for the dog to retrieve to dangling a ball of yarn for the cat to swat, these activities provide pets with amusement and warm the hearts of owners when they see their beloved companions filled with such delight. Beneficial to an animal's spirit, playing with their owners also affords pets much needed exercise and energy release.

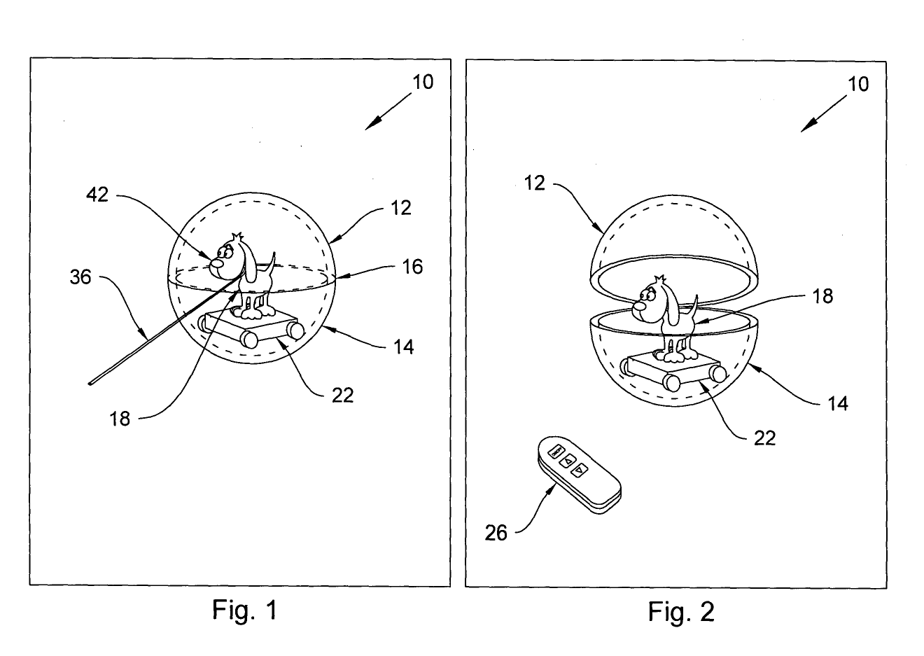

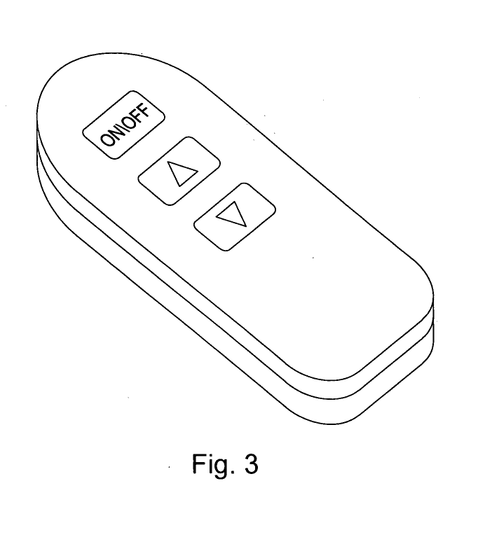

The present invention, hereinafter referred to as the Fun Ball, is a remotely controlled and sound activated toy for pets. The Fun Ball provides dog and cat owners with a fun and whimsical toy that allows them to interact with their pets in a manner that promotes activity and exercise, while also keeping pets company when their owners are away. Please refer to the Figures. The sizable and spherical hollow Fun Ball 10 is divided into two sections and hinge mounted at its center to facilitate opening and closing. Top section 12 is hingedly mounted to lower section 14 by hinge 16. Comprising a transparent plastic construction, the Fun Ball contains a second toy 18 inside such as a mouse for cats or a bone for dogs. The inside toy 18 is mounted on a wheeled platform 22, which causes the interior toy to roll against the inner walls of the ball while the Fun Ball is in motion. FIGS. 1 and 2 show second toy 18 as being a cartoon-like dog, but any suitable toy can be used.

The Fun Ball contains a receiver chip (not shown) that works in tandem with a transmitting, companion remote control device 26, shown in FIG. 3. This remote has a button 28 for turning the unit on and off, as well as directional arrows 32, 34 to move it forward and backward. The Fun Ball has a sound activating component to the receiver, which causes the Fun Ball to activate and engage whenever an external sound is emitted. An optional voice recorder 42 is added to the Fun Ball, allowing owners to leave comforting messages for their pets while they are away. In FIG. 1, the activation button 42 for recording a personal message is the dog's nose. The Fun Ball also contains a laser light 36 which emanates from the inside toy. In FIG. 1, the laser light is emitted from the dog tag around the dog's neck. Power to this device is provided by an internally contained, replaceable battery source such as AA alkaline. In an embodiment, the batteries can be rechargeable.

Use of the Fun Ball is very simple and straightforward. When playing with a pet, the user places the Fun Ball on the floor by the pet. After turning the remote power switch to an On position, the user presses a directional button to start the ball rolling. Once capturing the animal's attention, the user employs the remote to move the ball in any direction. The animal chases the Fun Ball around the room, delighting in the endeavor of capturing the elusive bone or toy cat. For a pet that spends the day alone, The Fun Ball is activated by sounds such as a bark from the dog, a phone ringing or a doorbell chiming.

A remote and sound activated toy that doubles as a rolling ball and fun character for a pet to chase, the Fun Ball creates attention grabbing motion that a dog or cat wants to chase. Household pets are amused for hours while also receiving an exercise and energy release that is essential to their health and well being. Pet owners delight in watching their companions scramble after a high velocity ball as the animal's spastic and frenzied attempts to capture the object inspire laughter and merriment. Encouraging a healthy body as well as spirit for a pet, the interactive Fun Ball provides both mental and physical stimulation. Made of durable, high quality materials and components, the Fun Ball will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A remotely controlled and sound activated interactive fun pet toy comprising:
a transparent, spherical hollow ball divided into two sections and hinge mounted at its center to facilitate opening and closing, wherein top section is hingedly mounted to lower section by a hinge; further comprising a second toy inside, wherein the second toy is mounted on a wheeled platform which causes the second toy to roll against the inner walls of the ball while the ball is in motion.

2. The pet toy of claim 1 further comprising: a receiver chip shown that operates with a transmitting companion remote control device, wherein the remote control device has a button for turning the toy on and off, and button having directional arrows to move the toy forward and backward.

3. The pet toy of claim 2, further comprising a sound activating component to the receiver chip, which causes the toy to activate and engage whenever an external sound is emitted.

4. The pet toy of claim 3, further comprising a voice recorder, to allow users to record a message for their pets.

5. The pet toy of claim 4, wherein the second toy is a dog having a nose, and activation button for recording a message is the dog's nose.

6. The pet toy of claim 3, further comprising a laser light which emanates light from the inside toy.

7. The pet toy of claim 6, wherein the second toy is a dog having a dog tag and the laser light is emitted from the dog tag around the dog's neck.

8. The pet toy of claim 2, further comprising a power source, wherein the power source is an internally contained replaceable battery source.

9. The pet toy of claim 8, wherein the battery source comprises one or more rechargeable batteries.

10. The pet toy of claim 3, further comprising a power source, wherein the power source is an internally contained replaceable battery source.

11. The pet toy of claim 10, wherein the battery source comprises one or more rechargeable batteries.

12. The pet toy of claim 4, further comprising a power source, wherein the power source is an internally contained replaceable battery source.

13. The pet toy of claim 12, wherein the battery source comprises one or more rechargeable batteries.

14. The pet toy of claim 6, further comprising a power source, wherein the power source is an internally contained replaceable battery source.

15. The pet toy of claim 14, wherein the battery source comprises one or more rechargeable batteries.
